(19) United States
(12) Patent Application Publication
(10) Pub. No.: US 2013/0091420 A1
(43) Pub. Date: Apr. 11, 2013

(54) Flyer Content Integration System

(71) Applicants: David SHIN, North York (CA); David MEYERS, Mississauga (CA); Jeff FRANCIS, Oakville (CA); Matthew CHEUNG, Mississauga (CA); Wehuns TAN, Oakville (CA)

(72) Inventors: David SHIN, North York (CA); David MEYERS, Mississauga (CA); Jeff FRANCIS, Oakville (CA); Matthew CHEUNG, Mississauga (CA); Wehuns TAN, Oakville (CA)

(21) Appl. No.: 13/268,107

(22) Filed: Oct. 7, 2011

(51) Int. Cl. G06F 17/20

(52) U.S. Cl. 715/255

(57) ABSTRACT

In this disclosure, a flyer content integration system and method is disclosed. The system includes a request processing module for receiving an integration request from an integration trigger module embedded in an editorial and a content integration module for creating a subset of flyer content from a collection of pre-selected digital flyer content for the editorial, the subset being created based on location of a viewer of the editorial and availability of the digital flyer content.

### TECHNICAL FIELD

The present disclosure relates to editorials and, in particular, to a system and method for integrating flyer content into editorials.

### BACKGROUND

Publishers of traditional print media, such as print newspapers and magazines, used advertisements as a secondary source of revenue. These advertisements were often separated from the editorial content, such as in the classified section, or were circulated with the print media as separate inserts. For example, a newspaper contained a bundle of print flyers. However, with the digital revolution, the revenue model for publishers changed significantly, converting these once secondary sources of revenue to the main source of revenue.

In order to maximize revenue generation, publishers began integrating advertisements into editorials. For example, an editorial about sports included advertisements for sporting goods. However, current systems used by publishers and editors (hereinafter referred to as “editorial producer) to insert revenue generating advertisements require a degree of manual input from the editorial producer. For example, the editorial producer may need to indicate that sporting goods are required or choose a specific product to be inserted into the editorial. The disadvantage with such systems is the level of input required from the editorial producer, who may not have any retail experience. Moreover, such systems often do not match the look and feel of the editorials and are limited to advertisements. To minimize such manual input, some editorial producers place advertisements, such as in the form of banner ads, that require minimal input from the editorial producer. However, such ads lack customization and often cannot match the look and feel of the editorials.

Additionally, one known system is designed to insert shopping products into tagged areas of pictures. However, the system is limited to pictures and shopping products.

Accordingly, systems and methods that address at least some of these shortcomings remain highly desirable.

### SUMMARY

According to an embodiment of the present disclosure, a flyer content integration system is disclosed. The flyer content integration system includes a request processing module for receiving an integration request from an integration trigger module embedded in an editorial; and a content integration module for creating a subset of flyer content from a collection of pre-selected digital flyer content for the editorial, the subset being created based on location of a viewer of the editorial and availability of the digital flyer content.

According to another embodiment of the present disclosure, a method is disclosed. The method includes receiving an integration request from an integration trigger module embedded in an editorial and determining existence of a collection of pre-selected digital flyer content for the editorial. If it is determined that the collection does not exist, the method further includes sending a request for creation of the collection to a flyer content creation server. If it is determined that the collection exists, the method further includes creating a subset of digital flyer content from the collection, the subset being created based on location of a viewer of the editorial and availability of the digital flyer content and making the subset available to an integration module in the editorial, the integration module for displaying the subset of flyer content in the editorial.

According to a further embodiment, a computer-readable storage medium comprising instructions in code which when loaded into a memory and executed by a processor of a communication device causes the communication device to perform the method above is disclosed.

In some embodiments, the collection of pre-selected digital flyer content is stored in memory.

In some embodiments, an integration request queue is included for enqueuing the integration request received by the request processing module and for dequeuing by the content integration module based on a dequeue priority.

In some embodiments, the dequeuing priority is based on one or more criteria, including location of the viewer, elapsed time since first integration request for the editorial, number of integration requests for the editorial, frequency of the integration requests for the editorial, trend of the integration requests for the editorial, or editorial producer associated with the editorial, or a combination thereof.

In some embodiments, a subset cache for storing the created subset is included.

In some embodiments, existence of the collection of pre-selected digital flyer content for the editorial is determined, and if it is determined that the collection does not exist, a request for creation of the collection is sent to a flyer content creation server; and if it is determined that the collection exists, a subset of digital flyer content is created from the collection, the subset being created based on location of a viewer of the editorial and availability of the digital flyer content; and the subset is made available to an integration module in the editorial, the integration module for displaying the subset of flyer content in the editorial.

In some embodiments, if it is determined that the collection does not exist, the integration module in the editorial is disabled.

In some embodiment, a rendering module is included for rendering the subset based on a style format.

In some embodiments, if it is determined that the collection exists, the subset is rendered based on a style format.

In some embodiments, the style format is based on structural layout, typeface, colour theme, dimensions of the editorial, content of the editorial, dimension of the integration module, or position of the integration module, or a combination thereof.

In some embodiments, the request for creation of the collection includes forwarding a copy of the integration request to the flyer content creation server.

In some embodiments, the subset is retrieved from the subset cache.

In some embodiments, the integration request is validated.

In some embodiments, the integration request is stored in memory.

### BRIEF DESCRIPTION OF THE DRAWINGS

Further features and advantages of the present technology will become apparent from the following detailed description, taken in combination with the appended drawings, in which:

FIG. 1 illustrates a block diagram of a communication system in which an embodiment of the present technology may be applied;

FIG. 2 illustrates a block diagram of an embodiment of the flyer content integration system;

FIG. 3 illustrates an exemplary editorial according to an embodiment of the present technology with integration trigger module and integration modules embedded;

FIG. 4 illustrates a process for integrating flyer content into an editorial according to an embodiment of the present technology;

FIG. 5 illustrates an interaction diagram between the editorial, flyer content integration system and flyer content creation system; and

FIG. 6 illustrates a block diagram of an embodiment of the flyer content creation system.

It will be noted that throughout the appended drawings, like features are identified by like reference numerals.

### DETAILED DESCRIPTION

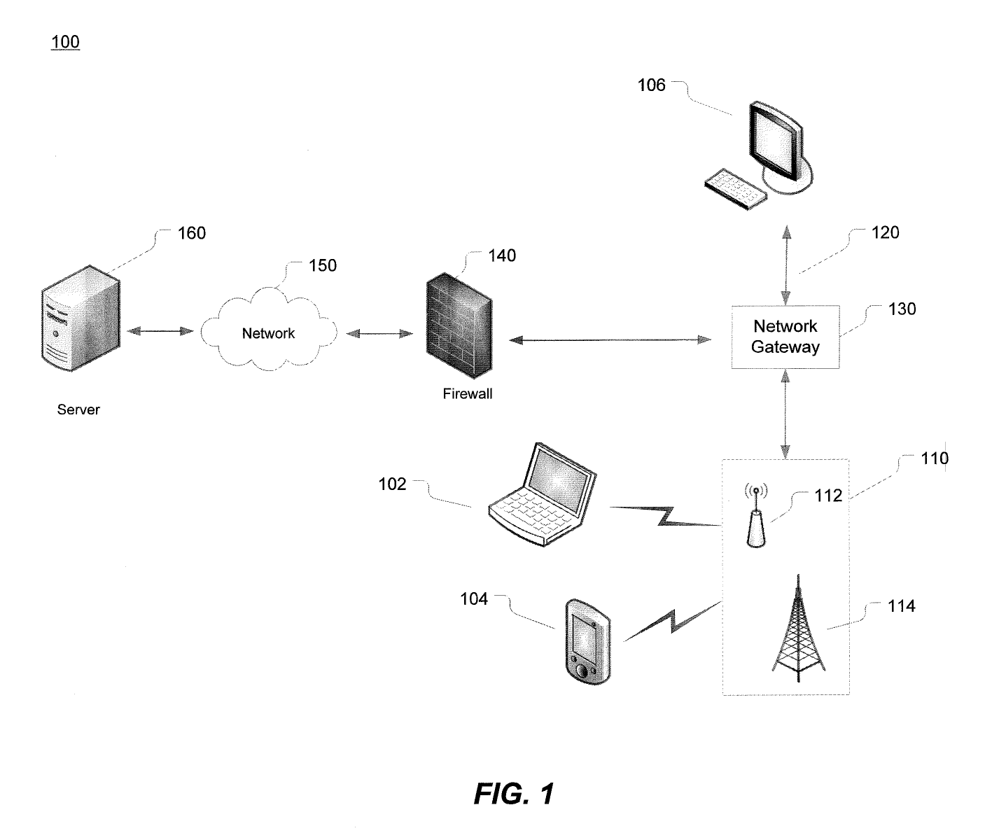

Embodiments are described below, by way of example only, with reference to FIGS. 1-6.

The present disclosure discloses a flyer content integration system that receives a request from an editorial having an integration trigger module and one or more integration modules. Editorial producers place one or more integration modules in areas where the editorial producer wishes to incorporate flyer content. The request for the flyer content integration is received by a flyer content integration system that creates a subset of flyer content from a collection of pre-selected flyer content potentially relevant to the editorial from which the integration request was received. With the subset created, the one or more integration module is able to display flyer content that is highly relevant to the editorial depending on the location of the viewer reading the editorial.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this disclosure belongs.

It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

The term “editorial producer” will be used to refer to the creator, author, editor or publisher of the editorial, in which the creator, author, editor or publisher desires to insert revenue generating flyer content.

The term “viewer” will be used to refer to any reader of the editorial.

The term “wireless communication technology” is intended to describe any communication protocol that enables a communication device to communicate with a server without wires. By way of example, but not limitation, wireless communication protocol may include IEEE 802.11x standards (sometimes referred to as Wi-Fi) such as, for example, the IEEE 802.11a, 802.11b, 802.11g, and/or 802.11n standard. Other communication protocols include: IEEE 802.16e (also referred to as Worldwide Interoperability for Microwave Access or “WiMAX”); IEEE 802.20 (also referred to as Mobile Wireless Broadband Access); Mobitex Radio Network, DataTAC; GPRS (General Packet Radio System); TDMA (Time Division Multiple Access) including GSM (Global System for Mobile Communication); CDMA (Code Division Multiple Access) including CDMA 2000 and UTRA (Universal Terrestrial Radio Access); FDMA (Frequency Division Multiple Access); OFDMA (Orthogonal FDMA), SC-FDMA (Single-Carrier FDMA); CDPD (Cellular Digital Packet Data); iDEN (integrated Digital Enhanced Network); EvDO (Evolution-Data Optimized); EDGE (Enhanced Data rates for GSM Evolution); UMTS (Universal Mobile Telecommunication Systems); HSPDA (High-Speed Downlink Packet Access); and other various network technologies, including LTE-advanced technologies. An OFDMA system utilizes Orthogonal Frequency Division Multiplexing (OFDM) and sends modulation symbols in the frequency domain on orthogonal subcarriers, and may be implemented in technologies such as E-UTRA or E-UTRAN.

Referring to FIG. 1, there is shown a block diagram of a communication system 100 in which an embodiment of the present technology can be applied. It should be expressly understood that this figure is intentionally simplified to show only certain main components. The communication system 100 may include other components beyond what is illustrated in FIG. 1.

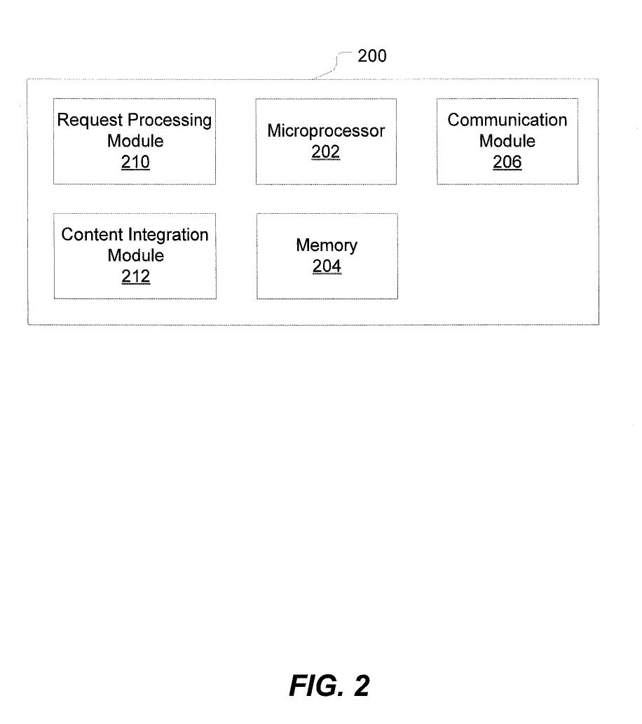

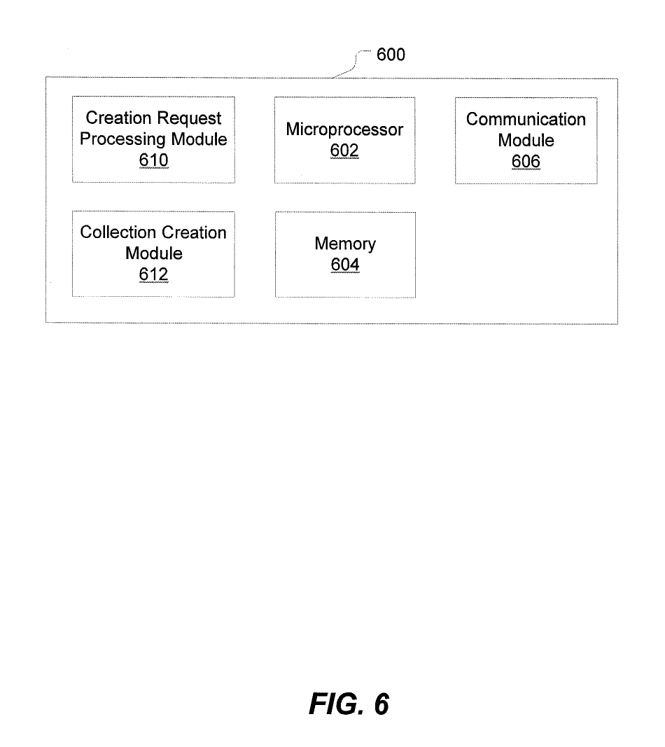

The communication system 100 includes a number of communication devices 102, 104, 106 which may be connected to other devices in the communication system 100 in any of several different ways. Accordingly, three different types of communication devices 102, 104, 106 are depicted in FIG. 1 employing different exemplary ways of connecting to other devices in the communication system 100. It should be expressly understood that communication devices other than those shown in FIG. 1 may be used to connect to the communication system 100. Communication devices 102, 104, 106 may be connected to, for example, the server 160 using wireless technologies or wired communication technologies. Editorial producers may use the communication devices 102, 104, 106 to integrate flyer content into editorials using the flyer content integration system (i.e. 200 in FIG. 2), which may be implemented on the server 160 as it will be described in details below. The server 160, or another server or computer system, may implement the flyer content creation system (i.e. 600 in FIG. 6).

In one embodiment, communication devices 102, 104 may connect to the server 160 using wireless communication technology 110. To facilitate the provision of wireless technology 110, there may be provided one or more wireless RF Access Points (AP) 112 and base stations 114.

In another embodiment, communication device 106 may connect to the server 160 using wired communication technology 120 such as IEEE 802.3 standard. Other wired communication technologies may be contemplated by a skilled person in the art.

Using wireless or wired technologies, communication devices 102, 104, 106 connect to the network gateway 130. The internal network 150 is typically behind a firewall 140, which serves to safeguard the internal network 150 from unauthorized access. Only authorized communication devices 102, 104, 106 are granted access to the server 160.

Turning to FIG. 2, a block diagram of the flyer content integration system 200 according to one embodiment in the present disclosure is shown. The flyer content integration system 200 includes a microprocessor 202, a memory 204 and a communication module 206. The memory 204 may be in the form of a random access memory (RAM), flash memory, magnetic disk, solid state drives or other forms of storage format. The communication module 206 may include wireless and wired communication technologies.

The flyer content integration system 200 further includes a request processing module 210 and a content integration module 212. As it will be further described below, the request processing module 210 receives a request for flyer content insertion, which is processed by the content integration module 212. In one embodiment, the flyer content integration system 200 may include an integration request queue for queuing the integration requests received by the request processing module 210. The queued integration requests will be dequeued by the content integration module 212 depending on a dequeue priority. In another embodiment, the flyer content integration system 200 may include a subset cache that stores previously created subsets in memory. This allows the request processing module 210 or the content integration module 212 to quickly respond to an integration request. The subset cache may be implemented in memory 204 or in any other memory. It will be understood that this figure is intentionally simplified to show only certain main components. The flyer content integration system 200 may include other components beyond what is illustrated in FIG. 2 and exclude some components as illustrated in FIG. 2.

Thus, using the flyer content integration system 200, an editorial producer is able to integrate flyer content into editorials with minimal input and effort. Even if the editorial producer has little retail experience, the flyer content integration system 200 is able to insert highly relevant flyer content into the editorial. Relevancy of the flyer content may be determined based on a number of criteria as it will be discussed below.

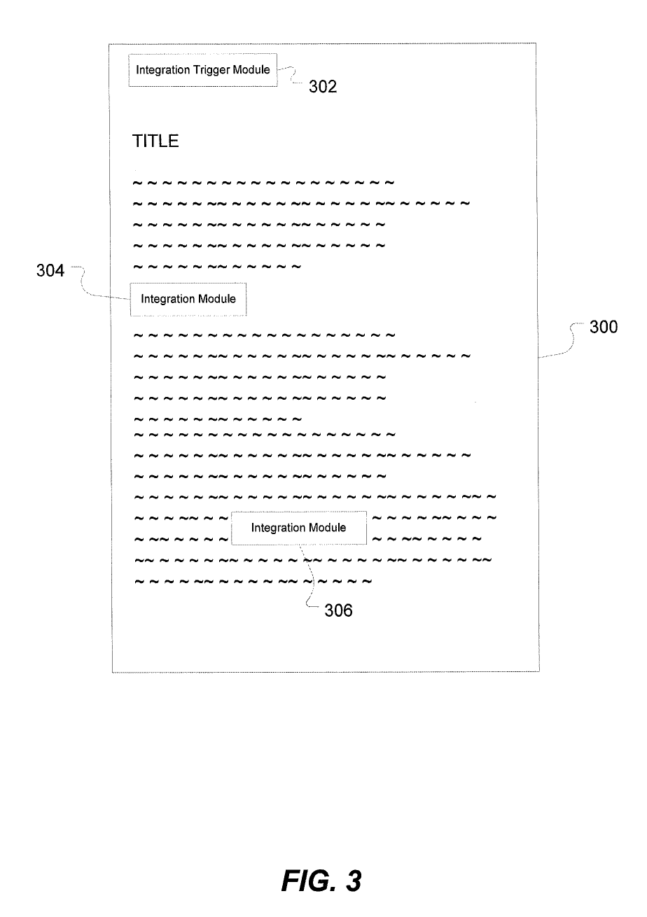

An exemplary editorial 300 is shown in FIG. 3. The editorial 300 includes an integration trigger module 302, which triggers a request to the flyer content integration system 200. In the areas that the editorial producer desires to insert flyer content, an integration module may be placed. In FIG. 3, the editorial 300 is shown with two integration modules 304, 306 inserted into the body of the editorial content. The integration modules 304, 306 serve as placeholders for the flyer content, which will be fed from the flyer content integration system 200. While the editorial 300 is shown with two integration modules 304, 306, it will be understood that an editorial may include one or more integration modules.

When the editorial 300 is loaded into a processor, for example, of a communication device, such as 102, 104 and 106 shown in FIG. 1, the integration trigger module 302 sends a request (herein referred to as “integration request”) to the flyer content integration system 200. In preparing the integration request, the integration trigger module 302 reviews the editorial to gather information about the one or more integration modules in the editorial. For example, it may locate the ID tag of the integration module. The ID tag may contain an identification number that is uniquely generated each time it is inserted into the editorial. If the integration module is removed and reinserted into another area of the editorial, the identification number would change. This information may also be used to determine the number of integration modules inserted into the editorial. Additionally, or alternatively, the integration trigger module 302 may determine the position of the integration module in the editorial. This information may help in determining if the editorial has changed since the last review. This information may also be used to choose the formatting style of the flyer content inserted into the integration module to match the look and feel of the editorial.

In addition to the foregoing information, the integration trigger module 302 may include the URL of the editorial, information about the editorial producer, and information about the current viewer of the editorial, including location information, in the integration request. The URL may be used by the flyer content integration system 200 to retrieve the editorial and the information about the editorial producer may be used to validate the editorial producer. The information about the editorial producer may be used to further tailor the type of flyer content inserted into the integration module.

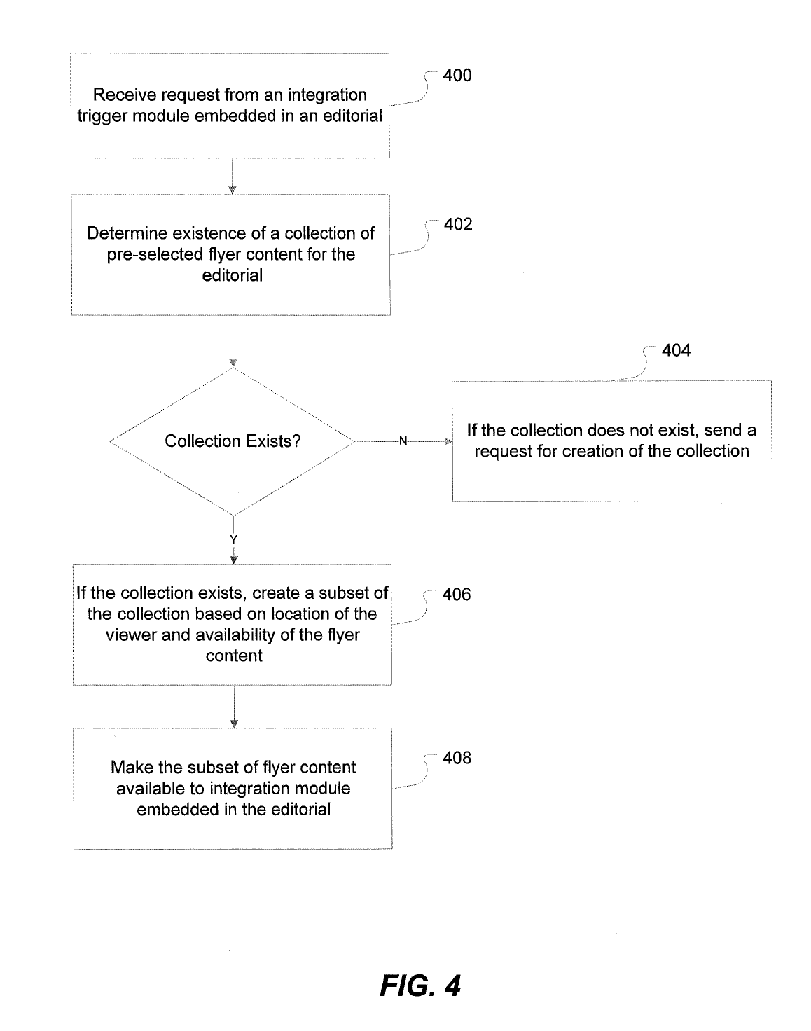

This integration request is then received by the flyer content integration system 200 (i.e. 400 in FIG. 4) by the request processing module 210. Upon receipt, the request processing module 210 may perform validation of the editorial producer to refuse integration request from an invalid editorial producer. The request processing module 210 may perform other validation, whether or not related to the editorial producer. In one embodiment, the request processing module 210 may queue the integration request in an integration request queue for retrieval by the content integration module 212 based on a dequeuing priority. The content integration module 212 reviews the integration request and determines if a collection of pre-selected flyer content exists for the editorial (i.e. 402 in FIG. 4). If the collection does not exist, a request is sent to the flyer content creation system (i.e. 600 in FIG. 6) to create the collection of pre-selected flyer content (i.e. 404 in FIG. 4). If the collection does exist, the content integration module 212 creates a subset of the collection based on location of the viewer and availability of the flyer content in the collection (i.e. 406 in FIG. 4). The subset of the flyer content created is then made available to the one or more integration modules embedded in the editorial 300 (i.e. 408 in FIG. 4).

In another embodiment, when the integration request is received and ready for processing, the request processing module 210 or the content integration module 212 may check a subset cache to determine if a subset was previously created for the editorial and the location of the viewer. For example, an editorial may receive thousands of views from the same location. If the request processing module 210 or the content integration module 212 determines that a subset for a particular location was previously created, all subsequent integration requests can be responded to without having to process the integration requests and thus, saving valuable processing resource. However, if it is determined that the cached subset has expired or requires update, then the content integration module 212 may re-create the subset.

### Flyer Content Integration Overview

Flyer content integration is a multi-stage process. The first stage is performed by a flyer content creation system (i.e. 600 in FIG. 6) that creates a collection of pre-selected potential flyer content for the editorial (hereinafter referred to as “collection creation”). This collection is the initial set of flyer content (hereinafter referred to as “flyer content collection”) that may be relevant to the editorial based on various factors, including the content and type of the editorial, viewers of the editorial and the editorial producer, information about the editorial producer, and any other relevant factors. Since the flyer content creation system stores or has access to large database of digital flyer content, the first stage is to create a “first cut” of the potentially relevant flyer content. The “first cut” of the flyer content (i.e. flyer content collection) is stored in memory 204 or any other memory that is accessible by the flyer content integration system 200.

The second stage of the flyer content integration process is initiated when the integration request is received by the request processing module 210 of the flyer content integration system 200. In one embodiment, the request processing module 210 may validate the integration request. For example, the request processing module 210 may determine if the integration request was sent from a valid editorial producer. In another example, the request processing module 210 may also verify whether the integration request contains all the requisite information. In a further embodiment, the request processing module 210 may store the integration request in memory (e.g. memory 204 in FIG. 2 or any other memory in or accessible by the request processing module 210 and the content integration module 212) to keep a history of the integration request and all the information contained therein. This information may contribute to the “request history information” discussed below. In an even further embodiment, the integration request may be queued in an integration request queue as discussed in this disclosure. The integration request queue may be similarly implemented as the queue for the collection creation request as discussed in this disclosure.

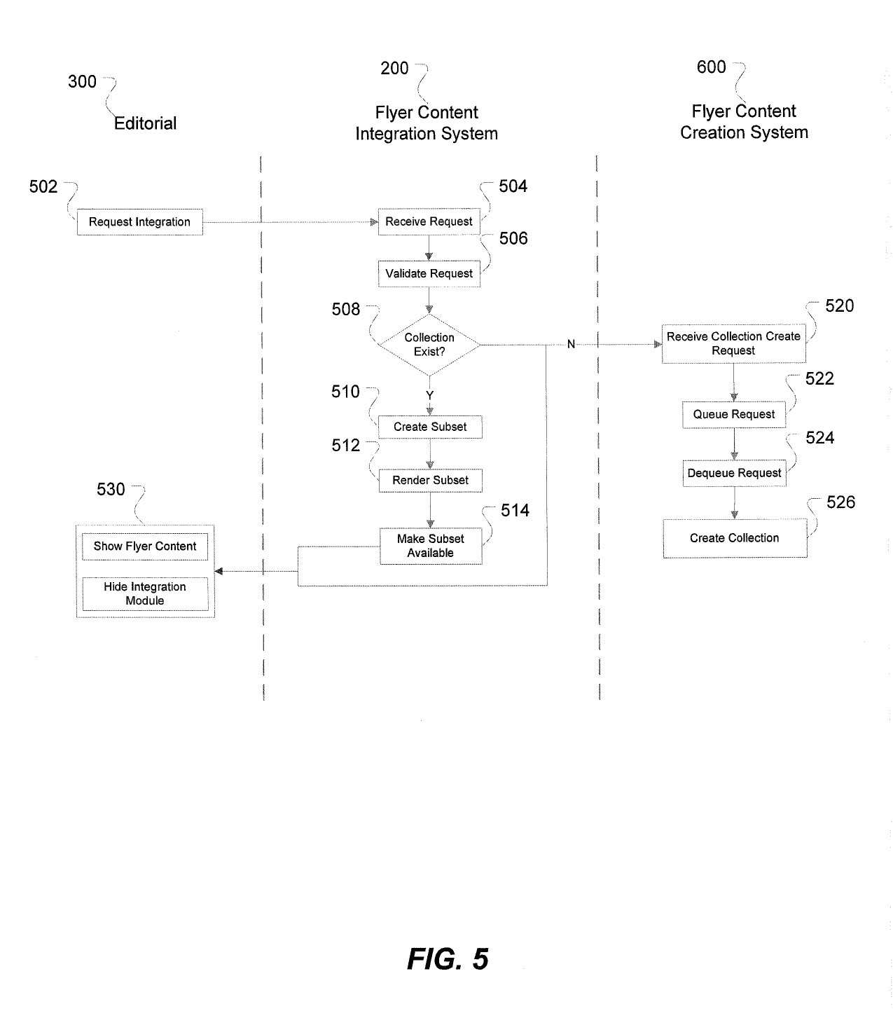

When integration request is ready for processing, the content integration module 212 determines if the flyer content collection is available for the editorial. If the collection is available, the content integration module 212 creates a subset of the flyer content collection based on the information contained in the integration request, in particular the location of the viewer, and the availability of the flyer content. Since flyers are local by nature, the content integration module 212 selects a subset of the flyer content collection that is highly relevant to the viewers, in particular to their location. Moreover, since the flyer content may have expired since the collection was created, the content integration module 212 also considers the availability of the flyer content when creating the subset. For example, the items in the flyer content may have been included in a weekly flyer. If the collection is unavailable, the flyer content integration system 200 alerts the flyer content creation system (see FIG. 5) that the flyer content collection for the editorial should be created. This alert is queued at the flyer content creation system for collection creation. When queuing the alert, information included in the integration request may also be included to aid the flyer content creation system in the creation process. While the foregoing has been described as a two-stage process, it will be understood that the flyer content integration process may be more than two stages.

Turning to FIG. 5, an overall, simplified and exemplary interaction diagram of the editorial 300, flyer content integration system 200 and the flyer content creation system 600 is shown. The editorial 300 requests for a flyer content integration to the flyer content integration system 200 (i.e. 502, 504 in FIG. 5). The flyer content integration system 200 may validate the integration request (i.e. 506 in FIG. 5). In one embodiment, the flyer content integration system 200 may implement a queuing system, e.g. an integration queue, for the integration request. In another embodiment, the flyer content integration system 200 may implement a cache, e.g. a subset cache as described in this disclosure, that stores previously created subsets. The cache may be updated to keep subsets only for frequently accessed editorials. Where the flyer content integration system 200 finds that a subset for the editorial and for the location of the viewer has been previously created and stored in the cache, the flyer content integration system 200 can retrieve the subset from the cache and make it available to the editorial 300. In other words, the flyer content integration system 200 is able to skip 508-512 in FIG. 5.

Where cache is implemented but the appropriate subset is not found, or the cache is not implemented, the flyer content integration system 200 determines if flyer content collection exists for the editorial (i.e. 508 in FIG. 5). If the flyer content collection does not exist, a collection creation request is sent to the flyer content creation system 600 (i.e. 520 in FIG. 5). The flyer content creation system 600 may queue the request and prepare the flyer content collection based on a dequeuing priority (i.e. 522, 524, 526 in FIG. 5). After creation of the flyer content collection, the created flyer content collection is stored in memory. The memory may be located on the flyer content integration system 200 or the flyer content creation system 600 or another server.

If the flyer content collection exists for the editorial, a subset of the flyer content collection is created (i.e. 510 in FIG. 5). The flyer content integration system 200 may render the subset content (e.g. using a rendering module) according to a pre-set style format that adheres to the look-and-feel and theme of the editorial (i.e. 512 in FIG. 5). This style format may have been created by the flyer content creation system 600 after considering the structural layout, typeface, colour theme, dimensions, and content (e.g. pictures) in the editorial. The flyer content creation system 600 may also consider the dimensions and location of the one or more integration modules in the editorial in creating the style format. The style format would be associated with the flyer content collection and stored in memory. The created or retrieved subset is then made available to and shown on the one or more integration modules in the editorial 300 (i.e. 514, 520 in FIG. 5). If the subset is not available and a request has been sent to the flyer content creation system 600, the integration modules is hidden or disabled (i.e. 520 in FIG. 5).

### Flyer Content Collection Creation

Flyer content collection creation is performed by the flyer content creation system 600. An exemplary block diagram of the flyer content creation system 600 is shown in FIG. 6. The flyer content creation system 600 includes a microprocessor 602, a memory 604 and a communication module 606. The memory 604 and communication module 606 may be similarly implemented as the flyer content integration system 200. The flyer content creation system 600 further includes a creation request processing module 610 for receiving a collection request from the flyer content integration system 200. In one embodiment, the flyer content creation system 600 may implement a queuing system that queues collection requests by the creation request processing module 610 (i.e. 522 in FIG. 5). The queued collection requests may be dequeued by the collection creation module 612 depending on a dequeue priority (i.e. 524 in FIG. 5). The dequeue priority may be implemented in a variety of ways. For example, the queued collection creation requests may be grouped together depending on the originating editorial. Since there may be a plurality of collection creation requests before the request is attended to by the flyer content creation system 600, the plurality of collection creation requests for the same editorial may be grouped together. Furthermore, the queued collection creation requests may be sorted based on one or more dequeuing criteria, including the location of the viewer, elapsed time since the first collection creation request for the editorial, number of collection creation requests for the editorial, frequency of the collection creation requests for the editorial, trend of the integration requests for the editorial, or editorial producer associated with the editorial, or a combination thereof. For example, if the integration trigger module 302 was embedded in a newspaper, the queued collection creation request may be given a higher dequeuing priority since newspaper articles are relevant for a short period of time. On the other hand, if the integration trigger module 302 was embedded in a magazine article, the relevant time of such an article is significantly longer than a newspaper article. Thus, such collection creation requests may be given a lower dequeuing priority. These and other “request history information” are collected, analyzed and stored in memory and used for the generation of the dequeue priority. The request history information may also be used in generating the flyer content collection.

The received collection creation request (whether queued or not) is processed by the collection creation module 612 (i.e. 526 in FIG. 5). This may involve analyzing the content of the editorial, the structural layout of the editorial, the location of the viewers, viewership of the editorial producer, or the position of the one or more integration modules in the editorial, or a combination thereof, to populate the flyer content collection. For example, information about the editorial producer may be used to tailor the type of flyer content inserted into the flyer content collection. A magazine website with a large corporate audience may be interested in different flyer content than a more entertainment oriented magazine website. Additionally, or alternatively, the flyer content creation system 600 may retrieve the request history information from memory to determine the relevant viewers of the editorial and the editorial producer. In one embodiment, creating the flyer content collection may involve creating a style format for the display of the flyer content collection that matches the look and feel of the editorial. This may involve analyzing the structural layout, typeface, colour theme, width of the integration module, and pictures in the editorial. This style format may then be stored in memory for access by the flyer content integration system 200.

In generating the flyer content collection, the flyer content is derived from print flyers. The print flyers may be digitized and contextualized using, for example, systems and methods disclosed in U.S. patent application Ser. Nos. 13/011,602 and 13/011,612, hereinafter referred to as “commonly owned patent applications” and which are incorporated herein by reference. These commonly owned patent applications describe a flyer image tiling technology and polygon mapping technology, among other technologies, to enhance the experience of the flyer viewer. These technologies can also be used to create the flyer content contained in the flyer content collection. An example of creating the flyer content collection using the flyer image tiling and polygon mapping technologies will now be described.

Print flyers may be scanned into a digital format and communicated, by the merchant, to the flyer content creation system 600, for example, using Adobe PDF® (Portable Document Format) or any other document or image format. In another embodiment, the print flyers may be scanned in directly into the flyer content creation system 600 by an administrator of the system. Minimal involvement from the merchant is required except for providing the flyer content creation system 600 with a digital flyer image of the print flyer or the administrator with the print flyer, which would be digitized into a digital flyer image for use by the flyer content creation system 600. The merchant is saved from providing a data feed to the flyer content creation system 600 like conventional systems.

The flyer image may be further digitized using tiling technology as disclosed in the above referenced commonly owned patent applications. This allows the flyer content to be retrieved at different resolutions and zoom levels that may be suitable for the editorial. Furthermore, the flyer image is contextualized using the polygon technology as described in the above referenced commonly owned patent applications. In this example, the polygons would be used to identify and tag the items that appear in the digital flyer. This allows the flyer content creation system 600 to assess and access each individual items on the digital flyer. In a further embodiment, each polygon may be further associated with supplementary information such as third party data, inventory data, product reviews, related items and any other relevant information that may be of interest to viewers. Using these technologies, the flyer content creation system 600 is able to generate the flyer content collection for use by the flyer content integration system 200. When a subset of the flyer content collection is inserted into the one or more integration modules in the editorial 300, the item level flyer content is shown embedded into the editorial, with minimal input from the merchant and the editorial producer. When a viewer clicks or otherwise engages with the item level flyer content, the viewer may also be presented with additional information that may be relevant to the item. For example, the additional information may include third party data, item review data, crowd-sourced information, video content, related item information and other relevant information.

While the above has been described using the technologies described in the above referenced commonly owned patent applications, it will be understood that other methods and technologies may be used to provide flyer content to the flyer content creation system 600 for the generation of flyer content collection. It will also be understood that the block diagram of the flyer content creation system 600 shown in FIG. 6 is intentionally simplified to show only certain main components. The flyer content creation system 600 may include other components beyond what is illustrated in FIG. 6 and exclude some components as illustrated in FIG. 6. It will also be understood that the flyer content creation system 600 may be a separate system from the flyer content integration system 200 or may be co-located with the flyer content integration system 200.

Therefore, the source of the flyer content collection is derived directly from the print flyers, thus relieving the merchant from providing the flyer content creation system 600 with a dedicated data feed. The flyer content creation system 600 then uses the information about the editorial, editorial producer and the viewers to create a collection of the flyer content. In creating this collection, the flyer content creation system 600 determines the available flyers, the locations relevant to the editorial and selects the flyer content that is relevant to such locations. With the flyer content collection created, the flyer content integration system 200 is able to create a subset from the flyer content collection, which is highly relevant to the viewers.

### Subset Creation

The flyer content collection is a pool of flyer content that is potentially relevant to the editorial and the viewers of the editorial. When the integration request is received by the flyer content integration system 200, it determines the most relevant flyer content by creating a subset of the flyer content collection based on a number of criteria.

In one embodiment, the flyer content integration system 200 creates a subset of the flyer content collection using the location of the viewer. Location of the viewer may be determined in a variety of ways including through explicit entry, device specific API (Application Programming Interface) functions, IP (Internet Protocol) geo-location and account profiles. Based on the viewer's location, a subset of the flyer content collection is created and made available to the integration module. The advantage of the pre-creation of a flyer content collection and thereafter selecting a subset of the collection will be described using an example.

Suppose there exists a local newspaper for Toronto that is read by local Toronto residents. The publisher of the local newspaper (i.e. the editorial producer) is also aware that residents of other nearby cities such as Hamilton, Kitchener and Barrie read the newspaper regularly. While these cities may be nearby, flyers applicable in Toronto may not be applicable in other cities. This is because of the local nature of flyers and the availability of advertised items may be limited to the cities in which the flyers are circulated. Thus, the flyer content creation system 600 creates a flyer content collection that includes flyer content relevant to viewers from not only Toronto but also Hamilton, Kitchener and Barrie. If the flyer content creation system 600 determines that there are significant numbers of viewers from another city (e.g. Vancouver), the flyer content creation system 600 may update the flyer content collection with flyer content also applicable to Vancouver residents. In one embodiment, the flyer content creation system 600 may require a minimum number of viewers from a location before deeming the location significant. This flyer content collection is stored in memory that is accessible by the flyer content integration system 200. When the flyer content integration system 200 receives the integration request, it determines the location of the viewer. If the viewer is from Hamilton, the flyer content integration system 200 creates a subset of the flyer content collection that is relevant to Hamilton and makes this subset available to the editorial. In a subsequent request, if the viewer is from Toronto, a new subset is created that contains flyer content relevant to Toronto. The subsets may be rendered using pre-determined style formats prior to making the subsets available. Moreover, the created subsets may be stored in a cache for later retrieval.

Therefore, a single collection of flyer content may be created that may be associated with the editorial, while the flyer content integration system 200 is able to serve a plurality of viewers originating from different locations and having different viewing characteristics.

While the patent disclosure is described in conjunction with the specific embodiments, it will be understood that it is not intended to limit the patent disclosure to the described embodiments. On the contrary, it is intended to cover alternatives, modifications, and equivalents as may be included within the scope of the patent disclosure as defined by the appended claims. In the description below, numerous specific details are set forth in order to provide a thorough understanding of the present patent disclosure. The present patent disclosure may be practiced without some or all of these specific details. In other instances, well-known process operations have not been described in detail in order not to unnecessarily obscure the present patent disclosure.

It is further understood that the use of relational terms such as first and second, and the like, if any, are used solely to distinguish one from another entity, item, or action without necessarily requiring or implying any actual such relationship or order between such entities, items or actions.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Some portions of the detailed description in the above are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the above discussions, it is appreciated that throughout the specification discussions utilizing terms such as “processing,” “computing,” “calculating,” “determining,” or the like, refer to the action and/or processes of a computer or computing system, or similar electronic computing media player device, that manipulate and/or transform data represented as physical, such as electronic, quantities within the computing system's registers and/or memories into other data similarly represented as physical quantities within the computing system's memories, registers or other such information storage, transmit session or display devices.

Embodiments within the scope of the present disclosure can be implemented in digital electronic circuitry, or in computer hardware, firmware, software, or in combinations thereof. Apparatus within the scope of the present disclosure can be implemented in a computer program product tangibly embodied in a machine-readable storage medium for execution by a programmable processor; and method actions within the scope of the present disclosure can be performed by a programmable processor executing a program of instructions to perform functions of the present disclosure by operating on input data and generating output. Embodiments within the scope of the present disclosure may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files. Embodiments within the scope of the present disclosure include computer-readable media for carrying or having computer-executable instructions, computer-readable instructions, or data structures stored thereon. Such computer-readable media may be any available media, which is accessible by a general-purpose or special-purpose computer system. Examples of computer-readable media may include physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system. Any of the foregoing can be supplemented by, or incorporated in, ASICs (application-specific integrated circuits). It should be understood that embodiments of the present disclosure may be used in a variety of applications. Although the present disclosure is not limited in this respect, the methods disclosed herein may be used in many apparatuses such as in the transmitters, receivers and transceivers of a radio system. Radio systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN), wireless metropolitan area networks (WMAN), wireless wide area networks (WWAN), or wireless personal area networks (WPAN, and the like).

What is claimed is:

1. A flyer content integration system comprising:
a request processing module for receiving an integration request from an integration trigger module embedded in an editorial; and
a content integration module for creating a subset of flyer content from a collection of pre-selected digital flyer content for the editorial, the subset being created based on location of a viewer of the editorial and availability of the digital flyer content.

2. The system according to claim 1, wherein the collection of pre-selected digital flyer content is stored in memory.

3. The system according to claim 1, further comprising:
an integration request queue for enqueuing the integration request received by the request processing module and for dequeuing by the content integration module based on a dequeue priority.

4. The system according to claim 3, wherein the dequeuing priority is based on one or more criteria, including location of the viewer, elapsed time since first integration request for the editorial, number of integration requests for the editorial, frequency of the integration requests for the editorial, trend of the integration requests for the editorial, or editorial producer associated with the editorial, or a combination thereof.

5. The system according to claim 1, further comprising a subset cache for storing the created subset.

6. The system according to claim 1, wherein the content integration module further determining existence of the collection of pre-selected digital flyer content for the editorial, and
if it is determined that the collection does not exist, sending a request for creation of the collection to a flyer content creation server; and
if it is determined that the collection exists,
creating a subset of digital flyer content from the collection, the subset being created based on location of a viewer of the editorial and availability of the digital flyer content; and
making the subset available to an integration module in the editorial, the integration module for displaying the subset of flyer content in the editorial.

7. The system according to claim 1, further comprising a rendering module for rendering the subset according a style format.

8. A method comprising:
receiving an integration request from an integration trigger module embedded in an editorial;
determining existence of a collection of pre-selected digital flyer content for the editorial;
if it is determined that the collection does not exist, sending a request for creation of the collection to a flyer content creation server; and
if it is determined that the collection exists,
creating a subset of digital flyer content from the collection, the subset being created based on location of a viewer of the editorial and availability of the digital flyer content; and
making the subset available to an integration module in the editorial, the integration module for displaying the subset of flyer content in the editorial.

9. The method according to claim 8, further comprising retrieving the subset from a subset cache.

10. The method according to claim 8, wherein if it is determined that the collection exists, further comprising storing the created subset in memory.

11. The method according to claim 8, wherein if it is determined that the collection exists, further comprising rendering the subset based on a style format.

12. The method according to claim 11, wherein the style format is based on structural layout, typeface, colour theme, dimensions of the editorial, content of the editorial, dimension of the integration module, or position of the integration module, or a combination thereof.

13. The method according to claim 8, wherein if it is determined that the collection does not exist, further comprising disabling the integration module in the editorial.

14. The method according to claim 8, wherein sending a request for creation of the collection to a flyer content creation server further comprises:
forwarding a copy of the integration request to the flyer content creation server.

15. The method according to claim 8, further comprising queuing the integration request.

16. The method according to claim 15, further comprising dequeuing the integration request based on a dequeuing priority.

17. The method according to claim 16, wherein the dequeuing priority is based on one or more criteria, including location of the viewer, elapsed time since first integration request for the editorial, number of integration requests for the editorial, trend of the integration requests for the editorial, or editorial producer associated with the editorial, or a combination thereof.

18. The method according to claim 8, further comprising validating the integration request.

19. The method according to claim 8, further comprising storing the integration request in memory.

20. A computer readable storage medium storing instructions or statements for use in the execution in a processor of a method for displaying applications on a mobile device, the method comprising:
receiving an integration request from an integration trigger module embedded in an editorial;
determining existence of a collection of pre-selected digital flyer content for the editorial;
if it is determined that the collection does not exist, sending a request for creation of the collection to a flyer content creation server; and
if it is determined that the collection exists,
creating a subset of digital flyer content from the collection, the subset being created based on location of a viewer of the editorial and availability of the digital flyer content; and
making the subset available to an integration module in the editorial, the integration module for displaying the subset of flyer content in the editorial.
